(19) United States
(12) Patent Application Publication
(10) Pub. No.: US 2009/0305183 A1
(43) Pub. Date: Dec. 10, 2009

(54) Bell-Mouthed Active Wing Bracket

(76) Inventor: Qifeng Chen, Fujian (CN)

Correspondence Address: Raymond Y Chan, 108 N Ynez Avenue, Suite 128, Monterey Park, CA, 91754, US

(21) Appl. No.: 12/308,674

(22) PCT Filed: May 15, 2007
(86) PCT No.: PCT/CN2007/001566

§ 371 Date: Dec. 17, 2008

(30) Foreign Application Priority Data
Jun. 26, 2006 (CN) 20062097467.3

(51) Int. Cl. A61C 7/14

(52) U.S. Cl. 433/8

(57) ABSTRACT

A bell-mouthed active wing bracket includes an immovable wing (11) combined with a bracket holder (1) and a movable wing (2) pivotally disposed on the bracket holder (1) by sliding. A “-” shape groove is formed between the immovable wing (11) and the movable wing (2). The space of the groove is adjustable. The interface plane of the “-” shape groove and the immovable wing (11) or the interface plane of the “-” shape groove and the movable wing (2) are declining. The two interface plane which are formed by the “-” shape groove intersecting with the immovable wing (11) and the movable wing (2) are declining, in order to form a bell-mouth, the top end of which is big and the bottom end of which is small.

### BACKGROUND OF THE PRESENT INVENTION

1. Field of Invention

This invention pertains to medical appliances field, specify improvement of a bell-mouthed active wing bracket for tooth corrected.

2. Description of Related Arts

The present frame of tooth corrected bracket includes a bracket holder which bottom back inosculate tooth, “-” shape groove design on the bracket holder surface, so the bracket holder surface separated by “-” shape groove become protrudent wing, ligation groove disposed on the outside of the protrudent wing for ligated. When use it, the bracket holder back connect to tooth, one holder for each teeth, then install a arch wire into the “-” shape groove, so the malposed tooth can be corrected with the elasticity of the arch wire. While because the malposed tooth are different and rule less, it is very difficult to install arch wire into the “-” shape groove. This inventor have two earlier inventions for bracket holder with movable wing, one design includes a bracket holder, two movable wings disposed on the bracket holder as two movable protrudent wings, so the space of the “-” shape groove is adjustable, the arch wire can be installed easily; other design includes a bracket holder, a protrudent wing connect the bracket holder as an immovable protrudent wing, other protrudent wing can move as a movable protrudent wing. It is proved in clinically practice, the other design is better, the protrudent wing is the location datum, the space of “-” shape groove can be adjusted via the movable wing adjusted, ligation is easier. But the interface plane of the immovable wing and the movable wing is erect, the arch wire is installed into the groove difficult, the operation is high difficulty, long time in the small tooth, lead the patient more pain.

### SUMMARY OF THE PRESENT INVENTION

The purpose of this invention is shown a bell-mouthed active wing bracket, the bracket is easier to install, adjust and use with better effect.

Technology description: A bell-mouthed active wing bracket includes an immovable wing combined with a bracket holder and a movable wing pivotally disposed on the bracket holder by sliding. A “-” shape groove is formed between the immovable wing and the movable wing. The space of the groove is adjustable. The interface plane of the “-” shape groove and the immovable wing or the interface plane of the “-” shape groove and the movable wing are declining. The two interface plane which are formed by the “-” shape groove intersecting with the immovable wing and the movable wing are declining, in order to form a bell-mouth, the top end of which is big and the bottom end of which is small. For the wide open of the bell-mouthed “-” shape groove, the arch wire can enter the bell-mouthed open easily when there is a downwards force, the arch wire also can drive the movable wing moved with component of bevel forces, the movable space become wider, then the arch wire is into the bottom of the “-” shape groove. Or to the serious malposed tooth, first the arch wire enter and ligate at the bell-mouthed open, then it is going into the “-” shape groove along with the bell-mouthed bevel following the malposed tooth corrected gradually.

This invention frame is simple, including the movable wing, the “-” shape groove with bell-mouthed, and the space of the groove is adjustable and lead the arch wire into the groove easily. Convenient operation in clinically, the arch wire deformation can be adjusted through the movable wing adjusted, so there is an appropriate corrective force to correct malposed tooth. Arch wire replacement decrease, so the clinically work and treatment time is also decrease.

These and other objectives, features, and advantages of the present invention will become apparent from the following detailed description, the accompanying drawings, and the appended claims.

### BRIEF DESCRIPTION OF THE DRAWINGS

Further description of this invention with the drawing:

FIG. 1 is the bell-mouthed active wing bracket 1 disconnected stereogram.

FIG. 2 is the bell-mouthed active wing bracket 2 disconnected stereogram.

FIG. 3 is the bell-mouthed active wing bracket 2 assembled stereogram.

FIG. 4 is initial state when the arch wire entering into the groove referenced drawing.

FIG. 5 is state after the arch wire entering into the groove referenced drawing.

| | | | | | | | |
|---|---|---|---|---|---|---|---|
| 1 | bracket holder | 11 | immovable wing | 12 | groove path | 13 | skid proof grain |
| 2 | movable wing | 21 | double insert | 3 | ligation groove | 4 | bevel |
| 5 | “-” shape groove | 6 | arch wire | | | | |

### DETAILED DESCRIPTION OF THE PREFERRED EMBODIMENT

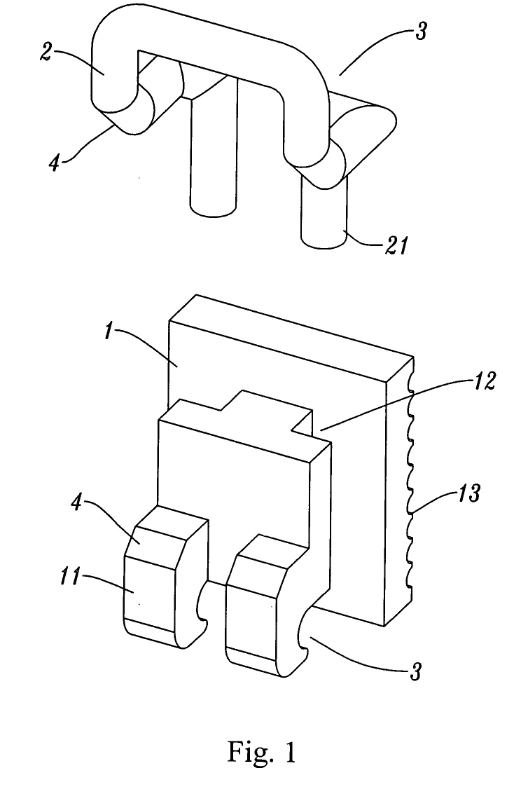

As FIG. 1, a bell-mouthed active wing bracket includes an immovable wing 11 combined with a bracket holder 1 and a movable wing 2 pivotally disposed on the bracket holder 1 by sliding, the bracket holder 1 is made of pressed steel material, the movable wing 2 is made of curved steel wire; groove path 12 disposed on the bracket holder 1, the double insert 21 of movable wing 2 can install into the groove path or move out the groove path. Because the movable wing 2 is made of curved steel wire, the double insert 21 is flexible, it can glide easily in the groove path and move out hardly. Ligation groove 3 disposed on the movable wing 2 and immovable wing 11, while the movable wing 2 and immovable wing 11 is reverse with each other, so the ligation wire can be fixed easily. The interface plane 4, namely, bevel 4 between the immovable wing 11 and movable wing are declining, and form the bell-mouthed “-” shape groove. The back bottom of the bracket holder is designed as skidproof grains to improve the tooth space mucosity.

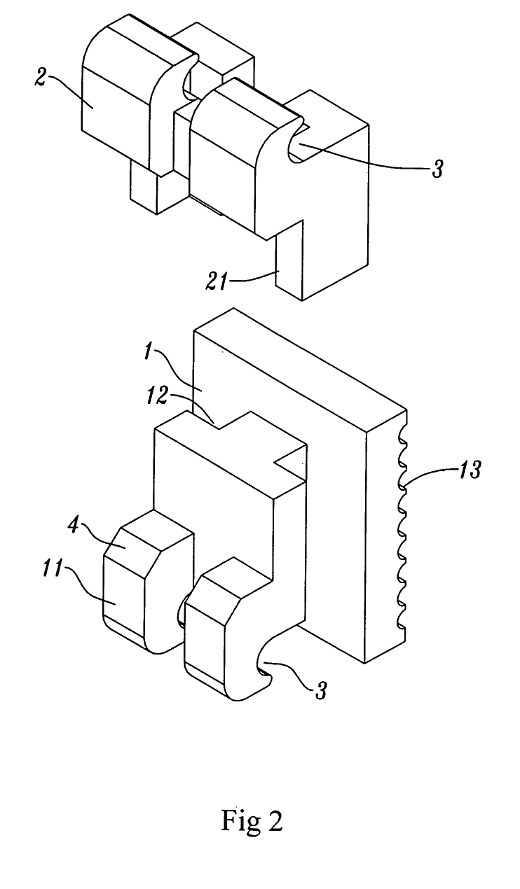

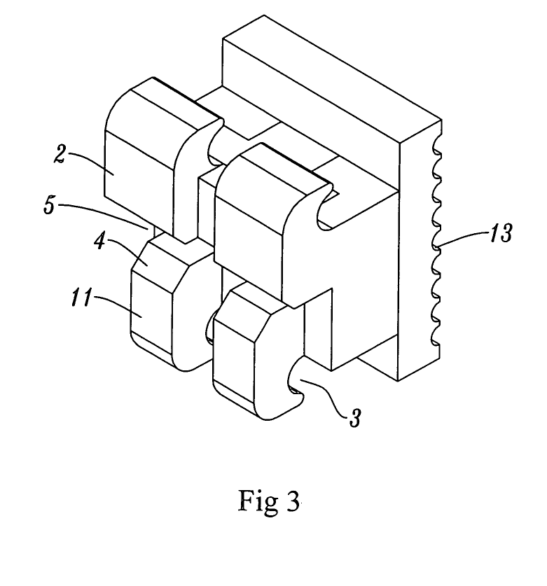

The formation of bell-mouthed active wing bracket in FIG. 2 and FIG. 3 is approximately same as FIG. 1. The only difference is just that the movable wing 2 is made of pressed steel material.

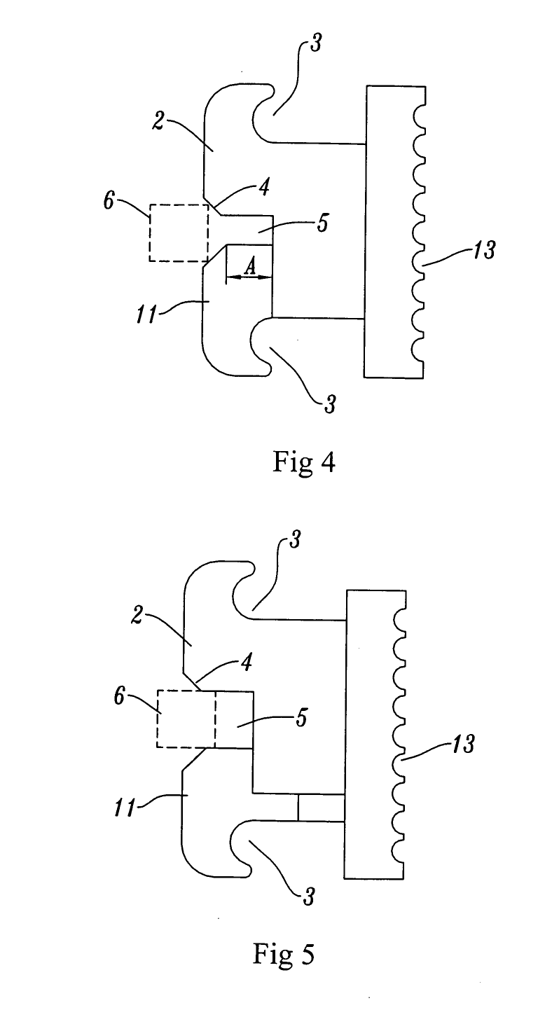

The initial state when the arch wire entering into the groove referenced drawing as FIG. 4 and the state after the arch wire entering into the groove referenced drawing as FIG. 5. The arch wire 6 and “-” shape groove 5 of bracket holder always isn't parallel because the malposed teeth are fluctuant. There is an angle between arch wire 6 and “-” shape groove 5 when arch wire 6 enters into the groove. Because of the bigger capability for bell-mouthed open, the arch wire 6 only lean to the wide bell-mouthed open of groove and be ligated. For a period of time after teeth corrected, the arch wire 6 will enter into the groove gradually with correcting, end with the correcting finished.

In addition, the arch wire 6 can't enter into the groove easily in traditional frame. While in this invention, the arch wire 6 lean to the wide bell-mouthed open of the “-” shape groove 5, when press arch wire 6, it can lead the movable wing 2 slip, then the “-” shape groove 5 become wider, the arch wire 6 can enter into the groove and be ligated easily. As FIG. 4 A, the space A is between the start of the declining interface plane and the bottom of the “-” shape groove, the space A is more than 0.2 mm to insure that the “-” shape groove 5 has a binding effect to correct tooth.

More than the above said frames, a single insert disposed on the middle of the movable wing 2, while a single groove disposed on the middle of bracket holder 1 to match with the single insert.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A bell-mouthed active wing bracket, comprising:
an immovable wing;
a bracket holder combined with said immovable wing;
a movable wing pivotally disposed on the bracket holder (1) by sliding;
a “-” shape groove which is formed between the immovable wing (11) and the movable wing; wherein a space of the groove is adjustable; wherein an interface plane of the “-” shape groove and the immovable wing or the interface plane of the “-” shape groove and the movable wing are declining.

2. The bell-mouthed active wing bracket, as recited in claim 1, wherein two said interface planes which are formed by the “-” shape groove intersecting with the immovable wing and the movable wing are declining, in order to form a bell-mouth of which the top end is big and the bottom end is small.

3. The bell-mouthed active wing bracket, as recited in claim 1 or 2, wherein said space between a start of the declining interface plane and a bottom of the “-” shape groove is more than 0.2 mm.

4. The bell-mouthed active wing bracket, as recited in claim 1, wherein the back of said bracket holder is designed as skidproof grain.
